(19) United States
(12) Patent Application Publication
(10) Pub. No.: US 2006/0155961 A1
(43) Pub. Date: Jul. 13, 2006

(54) Apparatus and method for reformatting instructions before reaching a dispatch point in a superscalar processor

(75) Inventors: James N. Dieffenderfer, Apex, NC (US); Richard W. Doing, Raleigh, NC (US); Sanjay B. Patel, Cary, NC (US); Steven R. Testa, Durham, NC (US); Kenichi Tsuchiya, Cary, NC (US)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORPORATION, ARMONK, NY (US)

(21) Appl. No.: 11/030,339

(22) Filed: Jan. 6, 2005

(51) Int. Cl. G06F 9/30

(52) U.S. Cl. 712/204

(57) ABSTRACT

Method and apparatus for reformatting instructions in a pipelined processor. An instruction register holds a plurality of instructions received from a cache memory external to the processor. A predecoder predecodes each of the instructions and determines from an instruction operation field where the instruction fields should be placed. A multiplexer reformats architecturally aligned instructions into hardware implementation aligned instructions prior to storing into L1 cache, so that the instructions are ready for dispatch to the pipeline execution units.

### BACKGROUND OF THE INVENTION

The present invention relates to the processing of instructions in a pipeline processor which are prefetched and stored in a cache memory. Specifically, an apparatus and method are disclosed which will reformat instructions prior to storing them in an L1 cache memory for hardware performance and/or alleviate critical timing paths in the decoder and dispatch stages.

Pipelined processors in state of the art superscalar processing systems are configured as a plurality of execution pipelines that can process a set of instructions in parallel. The instructions are written by programmers in accordance with a familiar programming language, and are compiled for execution into a series of machine readable instructions that the processing architecture is designed to process.

The pipelined processor may include various hardware devices which are controlled by instructions, such as a general purpose registers (GPRs) or function-execution units which have fixed read/write ports and function control ports. Each of the instructions must be decoded, analyzed and the fields aligned prior to dispatch to a GPR, function execution unit or control/hazard detection logic. Further, the pipeline processor may include data bypass logic and control/hazard detection logic to avoid the parallel processing of instructions which are not in a specified order, and which require the result of a previously executed instruction for their correct execution.

Decoding operations generally occur at the dispatch point where instructions have been received from cache memory and stored in a queue, and then forwarded to one of the pipelines for execution. In order to execute such instructions, the fields of the instructions must be properly aligned prior to dispatch to a pipeline execution unit. This is because the execution units are designed to be faster and more efficient when the GPR addresses and execution control fields are in the same location for all instructions. The misalignment of the instruction fields could be handled just before the execution units but this would burden the dispatch process particularly in a multi-way superscalar RISC design, which has to perform numerous complex dispatch/issue functions. The timing issues raised by performing these operations at the dispatch/issue point becomes very critical because of the complexity of dispatch/issue functions. There are several functions which have to be performed at this point, including pipeline assignments for instructions, decoding instructions, dispatch control, etc.

Accordingly, it is of interest to move the instruction realignment process from the dispatch/issue point where timing and performance demands are greatest.

### BRIEF SUMMARY OF THE INVENTION

An apparatus and method to reformat instructions in accordance with the invention before they reach a dispatch point for execution by a pipelined processor are provided. Instruction realignment is provided by swapping instruction fields before storing the instructions in the L1 cache of the processor.

In accordance with that preferred embodiment of the invention, instructions which are received from an L2 cache are pre-decoded so that a determination can be made whether or not the instruction fields are properly aligned for GPR addressing and execution unit controls. A multiplexer receives data on a plurality of inputs representing the data in each field of an instruction. The predecoder decodes the instruction operand to determine if any fields are to be swapped within the instruction, then multiplexer is enabled to provide an output of aligned instructions which have a format facilitating dispatch to the execution pipelines.

In accordance with the preferred embodiment, the realignment occurs prior to the storage of the instruction in the L1 cache of a pipelined processor, and accordingly, it alleviates the functional burden from the dispatch process. The reformatted instructions can be stored in the L1 cache, or when circumstances permit, directly forwarded to the decode unit of the pipeline processor where they may begin the dispatch process.

### BRIEF DESCRIPTION OF THE DRAWINGS

FIG. 1 is an example of a superscalar processor which executes instructions concurrently;

FIG. 2 shows the instruction cache and instruction unit including the apparatus for transferring instructions from a level 2 cache with a instruction realigning apparatus;

FIG. 3 demonstrates two typical instruction types word aligned in a fixed format.

FIG. 4 illustrates the reformatting of a Logical Instruction to a realigned logical instruction;

FIG. 5 illustrates the reformatting of an Arithmetic Instruction to a realigned arithmetic instruction;

FIG. 6 illustrates a Translation Lookaside Buffer Manipulate Instruction being reformatted to a realigned instruction.

### DESCRIPTION OF THE PREFERRED EMBODIMENT

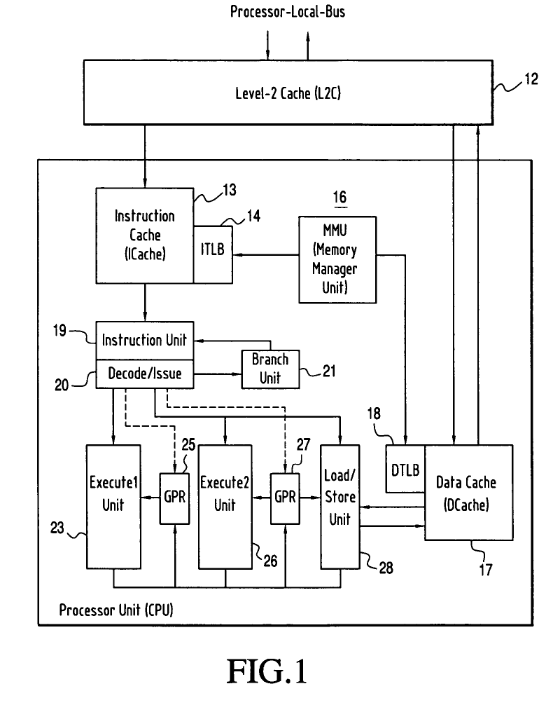

FIG. 1 is a high-level diagram of the major components of the Central Processing Unit (CPU) including certain associated cache structures, according to the preferred embodiment. Also shown in FIG. 1 is a L2 (Level 2) cache 12. The processor unit includes a L1 (Level 1) Instruction Cache (ICache) 13, Instruction Unit 19 having a Decode/Issue portion 20, Branch Unit 21, Execution Units 23 and 26, Load/Store Unit 28, General Purpose Registers (GPRs) 25 and 27, L1 data cache (DCache) 17, and Memory Management Units 14, 16 and 18. In general, Instruction Unit 19 obtains instructions from ICache 13, decodes instructions via Decode/Issue unit 20 to determine operations to perform, and resolves branch conditions to control program flow by Branch unit 21. Execution Units 23 and 26 perform arithmetic and logical operations on data in GPRs 25 and 27, and Load/Store Unit 28 performs loads or stores data from/to DCache 17. L2 cache 12 is generally larger than ICache 13 or DCache 17, providing data to ICache 13 and DCache 17. L2 cache 12 obtains data from a higher level cache or main memory through an external interface such as Processor-Local-Bus shown in FIG. 1.

Unlike registers, caches at any level are logically an extension of main memory. However, some caches are typically packaged on the same integrated circuit chip as the CPU, and for this reason are sometimes considered a part of the CPU. In the preferred embodiment, the CPU along with certain cache structures are packaged into a single semiconductor chip, and the CPU is referred to as a “CPU core” or “Processor core” to distinguish it from the chip containing ICache 13 and DCache 17. L2 cache 12 may not be in the CPU core although it may be packaged in the same semiconductor chip. The representation of FIG. 1 is intended to be typical, but is not intended to limit the present invention to any particular physical or logical cache implementation. It will be recognized that the CPU and caches are designed according to system requirements, and chips may be designed differently from those represented in FIG. 1.

The MMU 16 is controlled by the Privileged Programmer and contains the addressing environments for programs. Its main function is to translate/convert effective addresses (EA) generated by Instruction unit 19 or Load/Store unit 28 for instruction fetching and operand fetching. The instruction-microTLB (ITLB) 14 is a mini MMU to copy a part of the MMU 16 contents to improve the instruction EA translation, and the data-micro TLB (DTLB) 18 translates operand EAs. Both ITLB 14 and DTLB 18 provide MMU acceleration to improve CPU performance. The system of FIG. 1 is intended to be typical, but is not intended to limit the present invention to any particular physical or logical MMU implementation.

Instructions from ICache 13 are loaded into Instruction unit 19 using ITLB 14 for EA to real address translation prior to execution. Decode/Issue unit 20 selects one or more instructions to be dispatched/issued for execution and decodes the instructions to determine the operations to be performed or branch conditions to be performed in Branch unit 21.

Execution units 23 and 26 are associated with a set of general purpose registers (GPR) 25,27 for storing data and an arithmetic logic unit ALU (not shown) for performing arithmetic and logical operations on data in GPRs 25 and 27. The execution units receive instructions decoded by Decode/Issue unit 20. Execution units 23 and 26 may include a floating point operations subunit, a special vector execution subunit, special purpose registers, counters, control registers, complex pipelines and pipeline controls.

Load/Store unit 28 is closely inter-connected to execution units 23, 26 to provide data transactions from/to DCache 17 to/from GPR 27. In the preferred embodiment, execution unit 26 fetches data from GPR 27 for operand effective addresses (EA) generation to be used by Load/Store unit 28 to read and access data from DCache 17 using DTLB 18 for EA to real address (RA) translation, or to write access data into DCache 17 using DTLB 18 for its EA translation from EA to RA.

In the preferred embodiment, Decode/Issue unit 20 is a multi-instructions-issues design supporting the concurrent execution of multiple instructions and simultaneous dispatching/issuing of instructions in the same machine cycle. It is understood that this number of instructions dispatched/issued may vary and that the actual execution of instructions may overlap those issued in different cycles. In order to support concurrent multi-instructions-issues to multiple execution units 23,26 Load/Store unit 28, and GPRs 25,27, the instruction fields must always be aligned appropriately at the instruction issue point. In accordance with the present invention, it is proposed to align instructions before they are stored in the L1 ICache 13.

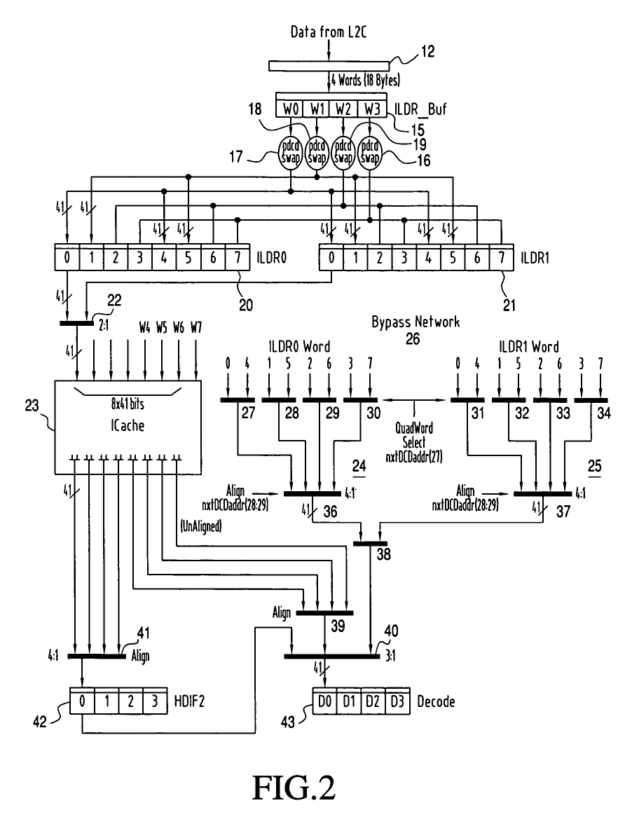

Referring now to FIG. 2, an instruction predecode/bypass arrangement in accordance with a preferred embodiment is illustrated which is used for reformatting instructions before they are stored in an L1 (Level 1) ICache 13. An external L2 cache 12 forwards instructions via a L2 cache interface 32 to an instruction buffer 35. In accordance with the process executed in the IBM PowerPC™ system, one half of a cache line of four byte words W₀, W₁, W₂ and W₃ may be transferred at a time from the L2 cache 12 to the buffer 35.

A predecode and realign circuit 36, 37, 38 and 39 predecodes and realigns each of the four instructions in the instruction buffer 35. As will be demonstrated with respect to various examples of instructions, if the instruction format is detected to be misaligned, certain fields of the instruction are exchanged with other fields to obtain a properly aligned instruction according to the hardware implementation.

The predecode circuits 36-39 may also provide other changes to the instruction. For instance, the instruction may be assigned a pipeline based on a predecoded function so that instructions of a given type are assigned a specific pipeline for execution thereby expediting their dispatch. This effectively requires an expansion of the instruction to include predecoded data identifying the pipeline.

The realigned instructions are stored in the instruction line data registers ILDR0 & ILDR1 (Instruction Line fill Data Register 0 & 1) 40 and 41 as one cache line of eight instructions. The cache lines are alternately loaded from each of the instruction line data registers 40, 41 to the L1 cache 13 through multiplexers 42 as one complete cache line.

The contents of the instruction line data registers 40, 41 may also be forwarded via a bypass network 46 to the decode stage 63 when the cache line is first accessed because of an ICache 13 miss, while it is written to the L1 ICache 13. Multiplexers 47-50 receive the outputs from the instruction line data register 40, and multiplexers 51-54 receive each of the reformatted instructions from the instruction line data register 41. Multiplexers 56, 57, 58 align instruction order and select the proper cache line for each of the instructions applied to multiplexer 60. The decode stage 63 accepts four instructions at a time from either of the instruction line data registers 40, 41.

Alternatively, instructions can be loaded in the normal way, four words at a time, from the L1 cache 13 and multiplexers 59, 60 to decode unit 63. The additional register, HDIF2, 62 is provided for storing the other half of the cache line, since the cache line contains eight words, so that the instructions from HDIF2 62 register can be loaded via multiplexer 60 to decode unit 63 while the instruction unit is pre-fetching the subsequent instruction streams/cache lines from L2 cache 12 on a L1 ICache 13 miss.

The present invention does not affect the loading of instructions from the instruction line data registers to either the cache or through the bypass network to the decode stage 63. It is located prior to the instruction line data registers 40, 41 so that the process executed downstream from data registers 40, 41 remains as in the prior art. However, because the predecoding and reformatting takes place prior to forwarding the instruction to either the level 1 ICache 13 or bypass network, they arrive at the dispatch stage in a properly reformatted structure.

The class of instructions which are reformatted by swapping fields to accommodate general purpose registers, and a function execution unit structure, include the following:

fixed point compare instructions;

fixed point trap instructions;

fixed point logical instructions;

fixed point shift/rotate instructions;

move to SPR (Special Purpose Register) class instructions;

TLB (Table Lookaside Buffer) manipulate instructions;

DST (Data Stream Touch) class instructions; and

special class instructions.

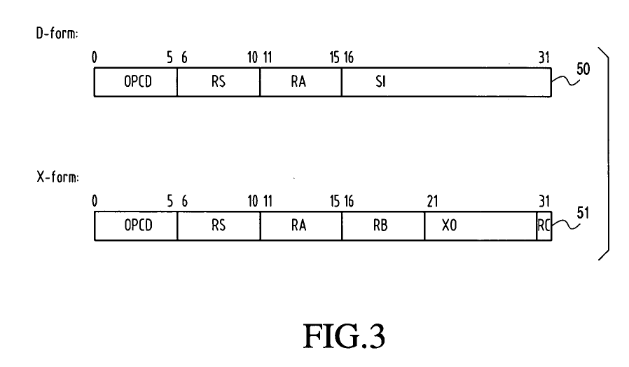

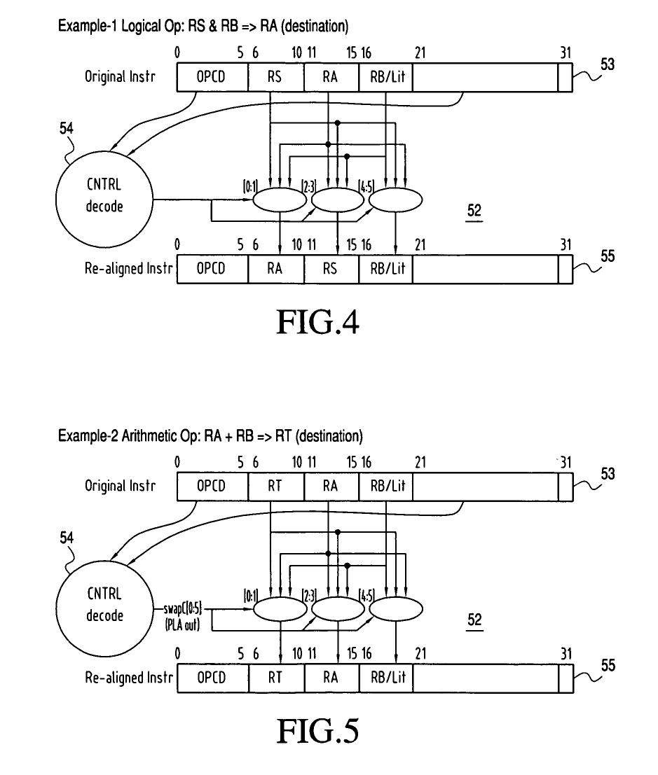

FIG. 3 illustrates the typical instruction format in the Big-Endian data structure which are four bytes long stored in buffer 35 of FIG. 2. The architecturally defined fixed formats include the D form, and the X form. The data formats include an instruction operation code field in bit positions 0-5, an RS (Source Register) specify field in bit positions 6-10 for the source operand register, and an RA (Source/Target Operand GPR) specify field in bit positions 11-15, as well as an SI (immediate Integer) field in bit positions 16-31. In the case of the X form, an RB (Source GPR) specify field and an XO (Extended Operation Code) field are included in the instruction. The reformatting takes place in the pre-decode stages 36-39 of FIG. 2. Typical realigning methods are illustrated in FIGS. 4-6, with respect to instructions which require field swapping.

FIG. 4 illustrates the logical instruction: RS & RB=>RA (destination). The original logical instruction 73 has a destination (or target) field RA which exists in bit positions 11-15, and a source GPR field RS which exists in bit positions 6-10. To align the instruction for the hardware implementation, so that the destination RA field appears in bit positions 6-10, and the source GPR RS field appears in bit position 11-15 the decode and control logic 74 decodes the OPCD field of the instruction and recognizes the misalignment and generate a control for realignment. Multiplexer 72 will switch the positions of data within the fields of bit locations 6-15 so that the realigned instruction 75 is obtained. The realigned instruction is therefore available from multiplexer 72 for storage in the instruction line data registers 40, 41 of FIG. 2.

FIG. 5 illustrates the reformatting of an arithmetic instruction. The arithmetic instruction 77, RA+RB=RT (destination), is in a form where the destination GPR address RT is contained in bit positions 6-10. As this aligns with the hardware implementation, no realignment occurs. The decode and control logic 78 identifies from the instruction operation code OPCD in bit positions 0-5, and the extended operation code (XO) in bit positions 21-30, that the correct format exists, and multiplexers 76 pass the fields forming instruction 79, which is unchanged.

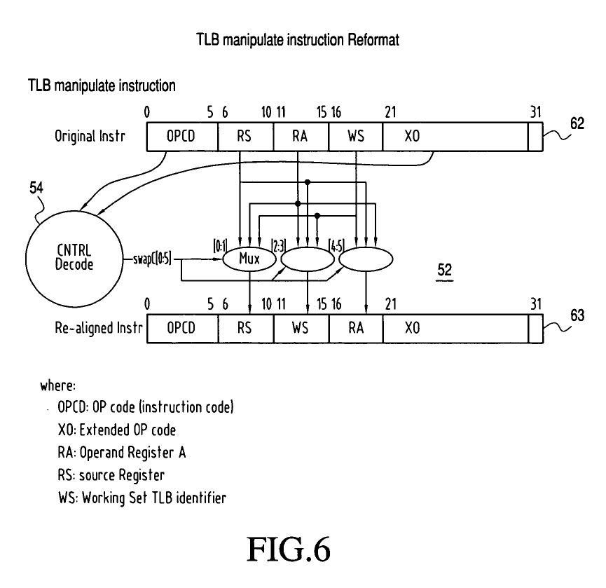

FIG. 6 illustrates a Translation Lookaside Buffer (TLB) manipulate instruction. The TLB manipulate instruction in buffer 35 of FIG. 2 is shown as 83, having a field WS, bit position 16-20, indicating the working set TLB identifier which is to be exchanged with the operand register A field (RA), bit position 11-15. After decoding the instruction operation code OPCD and the extended operation code XO field, decode control logic circuit 84 enables multiplexers 82 to swap positions of fields RA and WS to obtain a realigned instruction 85 at the output of multiplexers 82. The realigned instruction is then available for storage in the L1 cache, or to the bypass circuit where it may be transferred directly to the decode stage in the appropriate circumstance.

Thus, it has been shown how various instructions may be reformatted, so that the fields are appropriately aligned to meet the requirements of the processor hardware units. The reformat occurs prior to the L1 cache, and no additional burden is placed on the dispatch unit so that instructions may be received and dispatched already reformatted, and thus it reduces logic levels in the decode and dispatch units.

While the invention has been particularly shown and described with reference to preferred embodiments thereof, it will be understood by those skilled in the art that various changes in form and details may be made therein without departing from the spirit and scope of the invention.

What is claimed:

1. An apparatus for reformatting instructions before reaching a dispatch/issue point for execution by a pipelined processor comprising:
an instruction register for holding a plurality of instructions received from a cache memory external to said processor;
a predecoder for predecoding each of said instructions and for determining from an operation code whether said instruction fields are properly aligned; and
a multiplexer for reformatting said instructions into aligned instructions which have a format which facilitates dispatch to said pipeline processor in response to said predecoder determining that said instruction fields are not aligned.

2. The apparatus according to claim 1 wherein said multiplexer realigns a destination address of a logical operation instruction to have the same location as destination addresses of an arithmetic operation.

3. The apparatus according to claim 1 wherein said predecoded instructions are stored in first and second cache line data registers.

4. The apparatus according to claim 1 wherein said predecoder expands said instructions to include data identifying an execution pipe which is to receive said instruction.

5. The apparatus according to claim 1 further comprising a bypass circuit for bypassing said internal cache memory when said internal cache memory is a miss and said Decode stage is available to receive an instruction.

6. A method for reformatting instructions of a pipeline processor before they reach a dispatch point comprising:
storing said instructions in a buffer;
predecoding the operational code of each instruction to determine if the instruction is to be reformatted;
swapping fields of said instruction in response to said predecoding result.

7. The method according to claim 6 further comprising storing each reformatted instruction in a instruction line register means.

8. The method according to claim 6 further comprising expanding each instruction to include data identifying a pipeline assignment.

9. The method according to claim 6 wherein said predecoding step determines said instruction is an logical operation, and said places a destination address field in the same location as a destination address field of an arithmetic instruction.

10. The method according to claim 6 wherein said predecode stage assigns predecode bits to each instruction identifying a processing pipe to receive said instruction.

11. The method according to claim 10 wherein said instruction with said predecode bits is forwarded to an instruction cache of a pipeline processor wherein they are available for decoding and execution.
